(19) United States
(12) Patent Application Publication
(10) Pub. No.: US 2005/0027638 A1
(43) Pub. Date: Feb. 3, 2005

(54) Highly automated system for managing hedge funds

(76) Inventors: Cannan Ng, Irvine, CA (US); Rolf Fischer, Irvine, CA (US)

Correspondence Address: IRELL & MANELLA LLP, 840 NEWPORT CENTER DRIVE, SUITE 400, NEWPORT BEACH, CA, 92660, US

(21) Appl. No.: 10/632,019

(22) Filed: Jul. 30, 2003

(51) Int. Cl. G06F 17/60

(52) U.S. Cl. 705/37; 705/35

(57) ABSTRACT

A system and method for managing hedge funds is disclosed. The method comprises conducting market analysis to identify and filter a pool of financial instruments for the construction of a hedge portfolio database, conducting computerized quantitative analysis on combinations of the financial instruments in the hedge portfolio database to identify potential hedge positions, filtering at least one of the combinations based on filtering parameters to form a clearance combination, placing a trade order to open a hedge position based on the clearance combination, monitoring the hedge position to determine whether trading parameters have been met, and placing a trade order to close the hedge position. Other embodiments are disclosed and claimed herein.

### BACKGROUND OF THE INVENTION

1. Field of the Invention

The present disclosure relates generally to a method and apparatus for managing hedge funds and specifically to a highly automated system using computers to conduct market analysis, hedge analysis, simulation, clearance, trading, and accounting of a hedge fund.

2. Background Information

Unlike conventional equity or mutual funds, a hedge fund is a fund that can take both long and short positions and may invest in almost any opportunity in any market where it foresees impressive gains at reduced risk. A long position entails buying and holding a financial instrument such as a stock or equity in hopes that the stock or equity would rise in value over a certain period of time. A short position is taken by selling a financial instrument without owning it in the expectation that its price will drop, enabling the short seller to buy it back (or “cover” the short position) for a lower price at a future date. Investing equally in long and short positions (common in “market neutral” strategies) generally reduces market risk, but reliable market and hedge analysis is usually necessary to obtain meaningful results.

While the primary aim of most hedge funds is to reduce volatility and risk while attempting to preserve capital and deliver positive returns under all market conditions, the investment volatility, risk, and return among hedge fund strategies vary enormously. For instance, a macro hedge fund, which invests in stocks, bonds, and currencies in hopes of profiting on significant shifts in global interest rates and countries' economic policies, is generally more volatile but potentially faster growing than a distressed-securities hedge fund that buys the equity or debt of companies about to enter or exit financial distress. Some hedge find strategies which are not correlated to equity markets are able to deliver consistent returns with extremely low risk of loss, while others may be as or more volatile than mutual funds.

A relative value hedge fund takes advantage of price or spread inefficiencies. Performance of relative value strategies is not dependent on the direction of the bond or equity markets—unlike conventional equity or mutual funds, which are generally 100% exposed to market risk. Many such strategies exploit pricing inefficiences, but are limited as to how much capital they can successfully employ before returns diminish. As a result, many successful hedge find managers limit the amount of capital they will accept.

It is desirable in the hedge fund industry for a system that can implement a hedge fund strategy that is scalable to large amounts of capital, low risk, low volatility, independent of the overall market, accurate, transparent, and consistent.

### SUMMARY OF THE INVENTION

A system and method for managing hedge funds is disclosed. The method comprises conducting market analysis to identify and filter a pool of financial instruments for the construction of a hedge portfolio database, conducting computerized quantitative analysis on combinations of the financial instruments in the hedge portfolio database to identify potential hedge positions, filtering at least one of the combinations based on filtering parameters to form a clearance combination, placing a trade order to open a hedge position based on the clearance combination, monitoring the hedge position to determine whether trading parameters have been met, and placing a trade order to close the hedge position. Other embodiments are disclosed and claimed herein.

### DESCRIPTION OF THE DRAWINGS

FIG. 1 is a flow chart of an embodiment of a method for managing hedge funds.

FIG. 2 is a flow chart of an embodiment of the Economy stage in which market analysis is conducted to create a hedge portfolio.

FIG. 3 is a block diagram of an embodiment of a system for carrying out various stages of the method for managing hedge funds.

FIG. 4 is a flow chart of an embodiment of the Analysis stage in which hedge analysis is conducted to identify possible hedge candidates.

FIG. 5 is a flow chart of an embodiment of the Simulation stage in which simulation and optimization occur to identify the optimal values of the indicator variables.

FIG. 6 is a flow chart of an embodiment of the Clearance stage in which the hedge candidates may be filtered and monitored to clear them for trading.

FIG. 7 is a block diagram of an embodiment of a system for carrying out the Trading stage of the method for managing hedge funds.

FIG. 8 is a block diagram of an exemplary computer that may be used as an embodiment of the hedge fund computer.

FIG. 9 is a flow chart of an embodiment of a method for managing hedge funds.

### DETAILED DESCRIPTION OF THE EMBODIMENTS

While the present disclosure is open to various modifications and alternative constructions, the embodiments shown in the drawings will be described herein in detail. It is to be understood, however, that there is no intention to limit the invention to the particular embodiments disclosed. On the contrary, the intention is to cover all modifications, equivalents, and alternative constructions falling within the spirit and scope of the invention as expressed in the appended claims. It should also be noted that although the stages and steps in certain figures set forth herein are shown in order of intended implementation, those of ordinary skill in the art should recognize that the stages and steps in some cases may be rearranged, performed simultaneously, or omitted. It should also be appreciated that the examples provided in the present disclosure are merely provided as illustrations, and should in no way be construed to limit the scope of the disclosure.

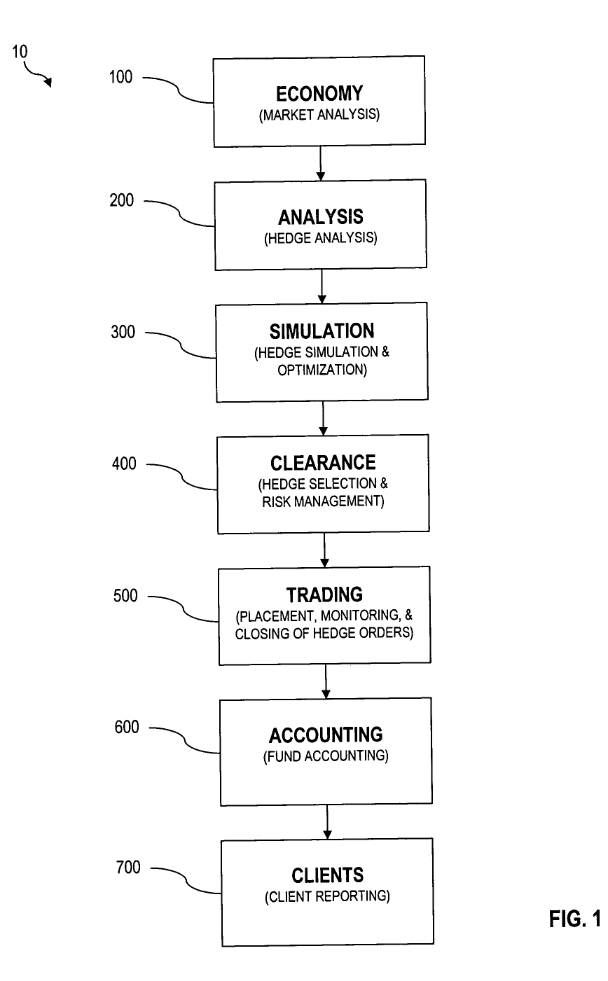

Referring to the drawings, FIG. 1 is a flow chart of an embodiment of a method for managing hedge funds containing stages identified as: Economy 100, Analysis 200, Simulation 300, Clearance 400, Trading 500, Accounting 600, and Clients 700.

### Economy

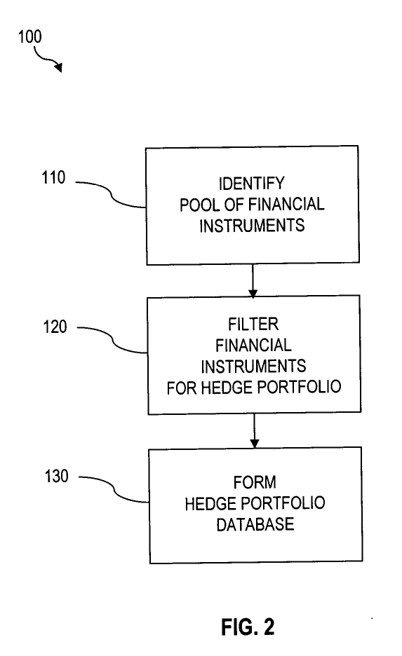

The Economy stage 100 involves conducting market analysis for the purpose of creating a hedge portfolio upon which hedge analysis is conducted. As illustrated in FIG. 2, there is shown a flow chart of an embodiment of the Economy stage 100 which may include the steps of identifying a pool of financial instruments (block 110), filtering the pool of financial instruments for a hedge portfolio (block 120), and constructing a hedge portfolio database based on the filtered result (block 130). The financial instruments (block 110) may comprise securities, money, stocks, options, bonds, notes, future contracts, commodities, commercial paper, certificates of deposit, Treasury-bills, index securities, security baskets, exchange traded funds (ETFs), contractual instruments, currencies, other forms of obligations, contracts, and property, or any combinations thereof. The filtering process (block 120) may be done based on market data such as industrial sectors, industry groups, industries, subindustries, geographic area, market share, sales revenue, earnings, market capitalization, price quotes, outstanding shares, earnings-to-share ratio, price-to-earnings ratios (“P/E ratios”), traded volume, average volume, unemployment rates, economic growth, GDP, assets, business history, volatility, length of time in a particular industry, bonds historical quote and data, bonds technical charts, bonds settlement prices, bonds historical prices, bonds historical volatility, bond historical open interest, bonds time and sales, bonds spread quote, federal funds rates, Federal Reserve Board's “beige book,” department of commerce reports, purchaser's report, commodities market report, commodities quote historical quote & data, commodities historical performance, commodities historical volatility, commodities historical volume, commodities receipts and shipments report, national GDP, national trade deficit, national debt, national GNP, national unemployment rate, national interest rates, currency supply and demand and/or other financial, fundamental, or economic data.

For instance, in one embodiment, the filtering process (block 120) may require the average volume of the particular financial instruments in a potential hedge position to be of sufficient magnitude such that a hedge position represents no more than a specified percentage of that volume. A person of ordinary skill in the art would understand that such a condition would be desirable because it would ensure that the opening or closing of the hedge position would not significantly affect the price of the financial instrument. In another embodiment, the filtering process (block 120) may limit the financial instruments to those from a particular region, such as the United States or Asian countries. In yet another embodiment, the filtering process (block 120) may limit the financial instruments to those from a particular set of industrial sectors or groups.

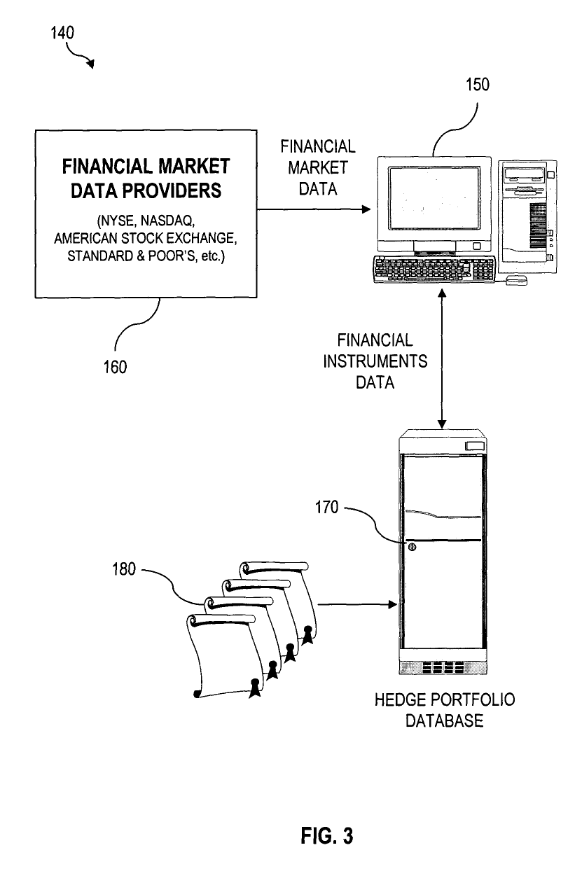

Referring to FIG. 3, there is shown a block diagram of an embodiment of a system 140 for carrying out various stages such as the Economy stage 100 including a hedge fund computer 150, financial market data providers 160, and a hedge portfolio database 170. The hedge fund computer 150 may communicate with the financial market data providers 160, such as Standard & Poor's, New York Stock Exchange, NASDAQ, American Stock Exchange, and/or other market information providers, to obtain financial data. The hedge fund computer 150 may automatically process the financial data and may identify a pool of financial instruments with which it constructs a hedge portfolio by storing data regarding the financial instruments in the hedge portfolio database 170. The constructed hedge portfolio database 170 may comprise individual financial instruments or groups of financial instruments, often referred to as “baskets” 180. The individual financial instruments may be selected and the baskets 180 may be created based on factors such as the size of the hedge fund, investment amount, number of available hedge positions, trade volume, tradeable groups of shares, P/E ratios, and/or other clearance and risk management criteria. As an example, a $10 million hedge fund may be divided into ten approximately equal hedge positions of $1 million each (e.g., $500K in a long position and $500K in a short position). The hedge fund computer 150 may filter out any financial instrument where a predetermined amount (e.g., $500K) of that instrument may represent a traded volume below a minimum percentage (e.g., 2% of average daily traded volume) to ensure liquidity.

### Analysis

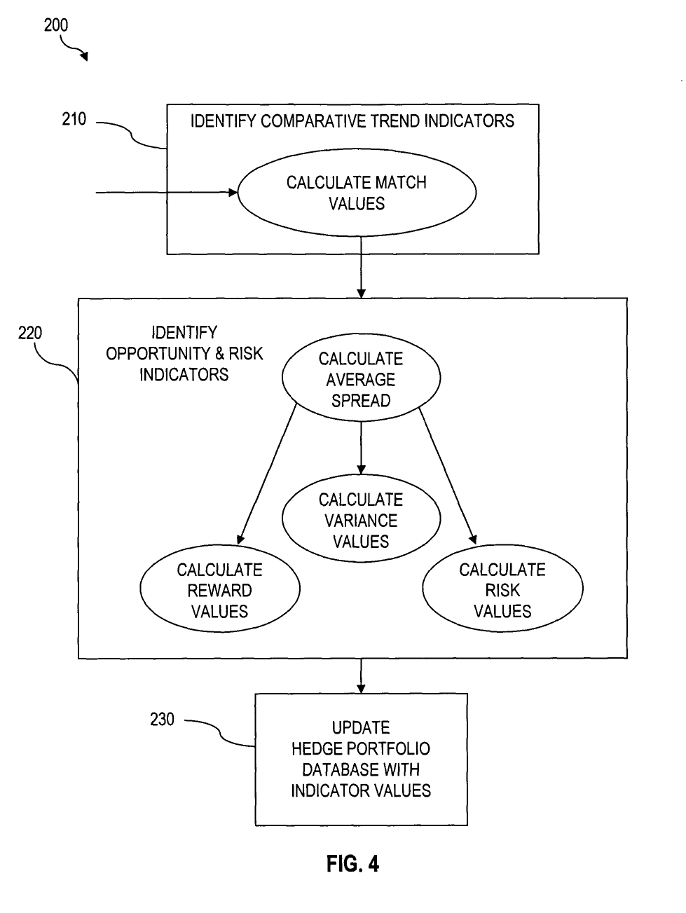

In one embodiment, the Analysis stage 200 involves conducting automated and computerized quantitative analysis on combinations of financial instruments in the hedge portfolio database to identify possible hedge position candidates. As illustrated in FIG. 4, there is shown a flow chart of an embodiment of the Analysis stage 200 which may include the steps of identifying indicators of comparative trends such as “match” variables (block 210), identifying indicators of opportunity and risk such as “average spread,”“reward,” “risk,” and “variance” variables (block 220), and updating the hedge portfolio database with the indicator variables (block 230). The indicator variables are used to identify combinations of financial instruments that have the greatest potential for hedging (“hedge combinations”). Hedge combinations may be comprised of one or more financial instruments of the same type, or may be comprised of dissimilar financial instruments (“cross hedging”). The indicator variables of each hedge combination may be divided into two general categories: (1) variables indicating trend; and (2) variables indicating opportunity and risk.

With respect to variables indicating trend, the “match” variable may represent how well the financial instruments that comprise a particular hedge combination track one another's price movements. Hence, it acts as a rough indicator of future trends in individual financial instruments. The more frequent the financial instruments in a potential hedge position match one another's price movements, the better the hedge combination becomes as a hedge candidate (since the movement of one security becomes an increasingly reliable indicator of the trend of the other). The “match” value may be calculated as a percentage of time that the securities in a hedge combination match in either upward or downward movements in their respective price, simple moving average, exponential moving average (which are moving averages weighted in favor of the most recent data), other types of moving average, accumulation/distribution line, Aroon and Aroon Ocillator, Average Directional Index (ADX), Average True Range (ATR), Bollinger Bands, Bollinger Band Width, Commodity Channel Index (CCI), Chaikin Money Flow, Chaikin Oscillator, MACD, Percentage Volume Oscillator (PVO), Price Oscillator (including PPO), Price Relative, Price by Volume, Rabbitt Q-Stock Rank, Relative Strength Index (RSI), Standard Deviation, Stochastic Oscillator, StochRSI, TRIN, VIX, Ultimate Oscillator, William %R, ZigZag, or other financial data as known in the art.

The “match” variable may be calculated based on the entire lifetime of the financial instrument, a predetermined time period, or variable time periods. As an example, the “match” variable may be calculated based on data taken from the last 240 trading periods. Assuming the simple case where one trading period equals one trading day, the “match” variable may be calculated based on the last year's worth of data. However, trading periods may be adjusted to be any unit of time (e.g., 20 minutes, one hour, one day, etc.), and thus funds may be made long-term funds or short-term finds simply by adjusting the trading periods.

Furthermore, trading periods may be customized to increase reliability, make calculations more efficient, and identify more hedge opportunities. As an example, in the case where baskets based on industrial indices are used to form hedge combinations, if the underlying industrial indices change, then the impact of these changes on the reliability of a hedge position may be minimized by shortening the trading period. Furthermore, when the time period over which the “match” variable is calculated increases, the reliability of the “match” variable as an indicator may also increase. On the other hand, when the time period over which the “match” variable is calculated decreases, the number of calculations required may be reduced. Finally, short-term trends and hedge opportunities may be identified more readily with shorter trading periods. With respect to variables indicating opportunity and risk, the “average spread” is a value that may represent the historical spread between financial instruments in a hedge combination, and may be used in the calculation of various variables indicating opportunity and risk. The “average spread” value may be calculated based on the average of the spreads between financial instruments of a hedge combination over a period of time. The spreads between financial instruments may be calculated as a number or a percentage of the initial, normalized value of the financial instruments, simple moving averages, exponential moving averages, accumulation/distribution line, Aroon and Aroon Ocillator, Average Directional Index (ADX), Average True Range (ATR), Bollinger Bands, Bollinger Band Width, Commodity Channel Index (CCI), Chaikin Money Flow, Chaikin Oscillator, MACD, Percentage Volume Oscillator (PVO), Price Oscillator (including PPO), Price Relative, Price by Volume, Rabbitt Q-Stock Rank, Relative Strength Index (RSI), Standard Deviation, Stochastic Oscillator, StochRSI, TRIN, VIX, Ultimate Oscillator, William % R, ZigZag, and/or other financial data as known in the art. As an example, assume that on Day 1, Security A was valued at $100 per share and Security B was valued at $200 per share. On Day 2, assume that Security A rose to $105 per share and Security B rose to $230 per share. As such, Security A increased by 5% whereas Security B increased by 15%. Hence, the current spread on Day 2 between Security A and Security B would be 10%.

The “reward” variable may be a measure of the discrepancy between the current spread and the historical spread of the hedge combination. The greater the discrepancy, the higher the reward possibility offered by the hedge combination. The value of the “reward” variable may be calculated based on the difference between (1) the current spread of the financial instruments in a hedge combination, and (2) the average spread of the financial instruments over a period of time. As an example, assume that Security A and Security B have an “average spread” of 15% over the course of 240 trading days. Assume that on the current day, Security A and Security B have an actual spread of 35%. Hence, the reward value maybe 35%−15%=20%.

The “risk” variable may be a measure of the discrepancy between the current spread and the maximum historical spread of the hedge combination. The greater the discrepancy, the higher the risk posed by the hedge combination (since the current spread may expand to the maximum historical spread or beyond). The value of the “risk” variable may be calculated based on the difference between (1) the current spread of the securities in a hedge combination, and (2) the maximum spread of the securities within a period of time.

The “variance” variable may be a measure of the likelihood of a larger-than-average or smaller-than-average spread between securities in a hedge combination to correct itself towards the “average spread.” The larger the value of the “variance,” the more likely a larger-than-average or smaller-than-average spread would correct itself in the direction of the “average spread.” The “variance” variable is calculated based on the percentage of time that the actual spread between securities in a hedge combination remains at or near the “average spread.” As an example, assume that Security A and Security B have an “average spread” of 15% over the course of 60 trading days. Assume that for 54 of the 60 trading days, the spread between the two securities was at or near 15%. Hence, the “variance” value may be 90%.

As with the “match” variable, the “average spread,” “reward,” “risk,” and “variance” variables may be weighted to favor more recent data and may be calculated based on customized time periods. The underlying financial information may be normalized in the situation of cross-hedging, where the hedge combinations are comprised of financial instruments of varying types or dissimilar financial markets. For instance, in a case where the financial instruments in a hedge combination are traded in different currencies, the prices may be converted into one currency to facilitate proper analysis. Also, it should be understood that the above description should in no way be construed to limit the scope of this invention to the above indicator variables and that other indicator variables may be used instead of or in conjunction with any combination of the above indicator variables. For instance, one indicator variable may involve a value representing the frequency or fluctuation period in the spread of a hedge combination. Furthermore, the computation required to calculate the various indicator variables may be performed automatically by the hedge fund computer 150 as depicted in FIG. 3, or a similar device. Referring to FIG. 3, the hedge fund computer 150 retrieves financial instruments data from the hedge portfolio database 170 and processes the financial instruments data in order to calculate the various indicator variables as disclosed above. The hedge fund computer 150 stores the resulting indicator variables in the hedge portfolio database 170.

### Simulation

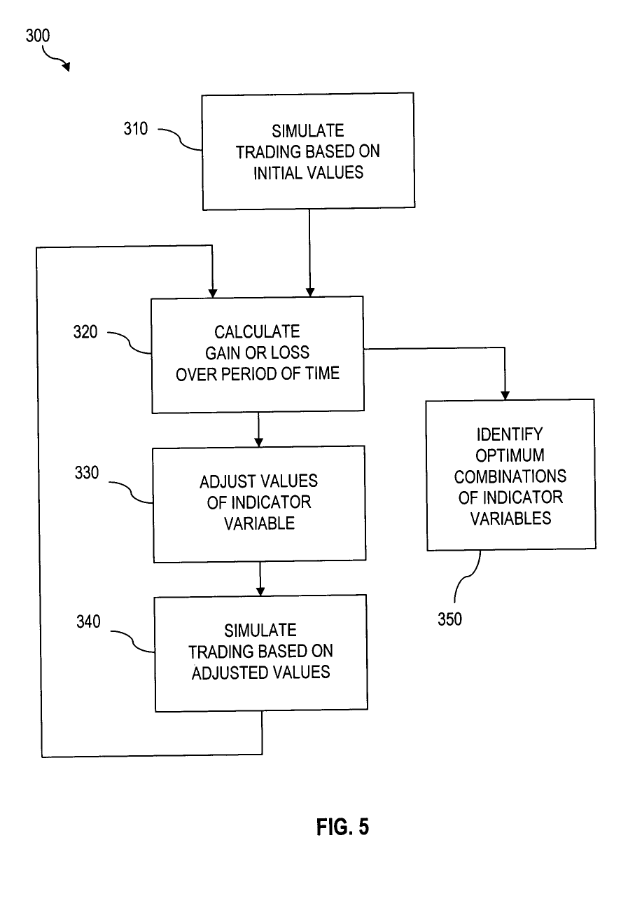

In one embodiment, the Simulation stage 300 involves the simulation of hedge fund trading/clearance based on the hedge fund portfolio in order to identify the optimal values of the indicator variables to be used as filtering parameters. As illustrated in FIG. 5, there is shown a flow chart of an embodiment of the Simulation stage 300 which may include the steps of simulating trading of hedge fund based on an initial set of values for the indicator variables (block 310), calculating the gain or loss over a predetermined period of time (block 320), adjusting the values of the indicator variables (block 330), simulating trading of hedge fund based on the adjusted set of values for the indicator variables (block 340), and repeating the process until the optimum combination of match, reward, risk, and variance values are achieved (block 350). The computations required to perform the calculations necessary in the simulation of trading may be performed by the hedge fund computer 150 as depicted in FIG. 3, or by a similar device, and the results may also be stored in the hedge portfolio database 170.

The results generated by the Simulation stage 300 may be a table or multi-dimensional graph that enables the optimum combination of indicator variables to be identified, as well as establish minimum required values for the indicator variables. The optimum combination may be a range of values for each filtering parameter that would return a consistently positive gain. In addition to the indicator variables mentioned above, other indicator variables may be incorporated into the simulated trading/clearance and used as filtering parameters such as P/E ratios, whether hedge components are in same sector, and other fundamental, market, or economic data. The Simulation stage 300 may run in parallel with the Analysis stage 200, and may update the clearance parameters in real-time.

### Clearance

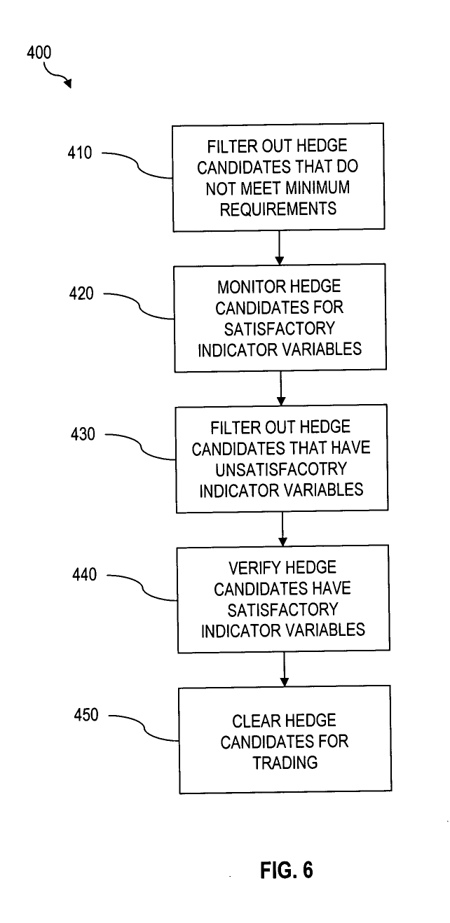

In one embodiment, the Clearance stage 400 involves the filtering and monitoring of hedge candidates based on current values of the indicator variables. As illustrated in FIG. 6, there is shown a flow chart of an embodiment of the Clearance stage 400 which may include the steps of filtering out hedge candidates that possess indicator variables that do not reach a minimum required value (block 410), monitoring the hedge candidates for current indicator variables (block 420), filtering out hedge candidates that possess current indicator variables that fall outside a satisfactory range (block 430) established by the filtering parameters calculated in the Simulation stage, verifying the remaining hedge combinations as satisfactory candidates (block 440), and clearing the hedge combinations to be traded (block 450). The computations required to calculate the current values of the various indicator variables may be performed automatically by the hedge fund computer 150 as depicted FIG. 3, or a similar device. Referring to FIG. 3, the hedge fund computer 150 may communicate with the financial market data providers 160, such as Standard & Poor's, New York Stock Exchange, NASDAQ, American Stock Exchange, and/or other market information providers, to obtain current financial data. The hedge fund computer 150 may process the current financial data to accomplish the above steps. The current financial data may be periodically refreshed by communicating with the financial market data providers 160 for updates.

At the Clearance stage 400 in one embodiment, hedge candidates may be filtered at various levels. At an initial level, any hedge candidate that does not meet a minimum requirement for indicator variables may be filtered immediately. Subsequent filtering may be accomplished based on various combinations of the “match,” “variance” “reward,” “risk,” or other filtering parameters. Generally speaking, by reducing the “reward” requirements (which would generate more hedge possibilities), stricter “risk” and “variance” requirements may be imposed, thus possibly producing safer and more reliable hedge candidates. In addition, the filtering process may also take into account minimum trade amounts for each hedge positions, and limit the clearance combinations, or cleared hedge candidates, to those having sufficient volume relative to the overall market capitalization. Furthermore, the filtering parameters may include the amount of available funds in the hedge fund, the relative momentum of the financial instruments, past behavior of the hedge combination in the fund (e.g., past combinations resulting in losses or negligible gain), whether there are any redundant financial instruments among the clearance combinations, whether there are preexisting same or similar financial instruments in the fund, whether the hedge combination demonstrates current abnormal behavior, and whether the hedge combination has been “frozen” for one reason or another. One of ordinary skill in the art should recognize that the larger a portion of the fund is allocated to a particular financial instrument, the more volume and liquidity may be desired for that particular financial instrument. Finally, other investment rules may be utilized in the filtering process based on factors including, but not limited to, relative P/E ratios, past performance of the hedge candidates, 52-week Highs and Lows, Average Daily Volume, Market Capitalization, Shares Outstanding, Float, Dividend Yield Percentage, Annual Dividend Yield, Payout Ratio, Quick Ratio, Current Ratio, Long Term Debt to Equity Ratio, Total Debt to Equity Ratio, Price to Sales Ratio, Price to Book Ratio, Price to Cash Flow Ratio, Earnings Per Share, Sales Per Share, Book Value Per Share, Cash Flow Per Share, Cash Per Share, Return on Equity, Return on Assets, Return on Investment, Gross Margin, Operating Margin, Profit Margin, or other financial information.

In one embodiment, the step of verifying the resulting hedge combinations as satisfactory candidates (block 440) involves confirming that the values upon which the indicator variables were calculated (e.g., price of a security, etc.) have not changed in a manner that affects the attractiveness of the particular hedge opportunity.

### Trading

In one embodiment, the Trading stage 500 involves the opening of hedge positions, monitoring the opened hedge positions, and closing the hedge positions based on specified trading parameters. A hedge position may comprise at least one long position and at least one short position taken at or about the same time. Unless the hedge positions are leveraged, the long and short positions may be relatively close in value. Furthermore, a hedge position may also comprise an arbitrage position in which an immediate “cash out” is possible.

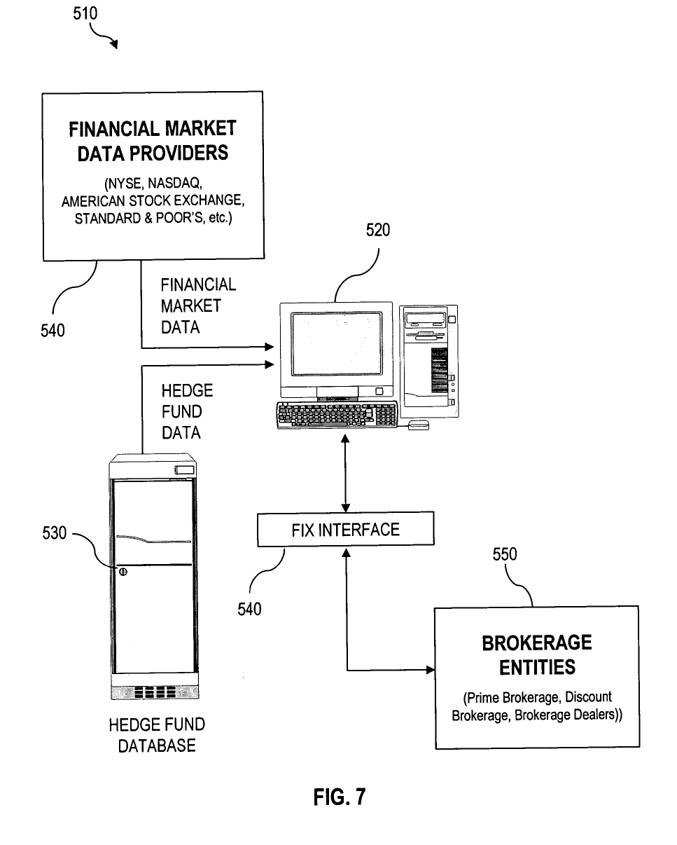

Referring to FIG. 7, there is shown a block diagram of an embodiment of a system 510 for executing trades including a hedge fund computer 520, hedge fund database 530, financial market data providers 540, and brokerage entities 550. The hedge fund computer 520 communicates with the financial market data providers 540, such as Standard & Poor's, New York Stock Exchange, NASDAQ, American Stock Exchange, and/or other market information providers, to obtain current quotes of the financial instruments used to form and monitor hedge positions. Based on the financial market data received from the financial market data providers 540 and the hedge fund data received from the hedge fund database 530, the hedge fund computer 520 communicates with the brokerage entities 550, such as a prime brokerage or brokerage dealer to place buy or sell orders.

The placement of the buy or sell orders may be automated and limited by trading parameters determined based on maximum bid/ask price deviations, minimum share block sizes, bid price, ask price, bid size, ask size, last price, change, % change, daily low, daily high, volume, previous close price, open price, last update, trend, open interest, last volume, or other financial data. The automation of the trading may ensure that the trading is executed according to a planned strategy, and thus may decrease the possibility of human error, inefficiencies, and subjectivity. To reduce lag time and enhance execution of trades, the hedge fund computer 520 may use a FIX interface 560 with the brokerage entities 550 in order to offer real-time execution of trades. Such an interface may ensure that the financial instruments are obtained at a price relatively close to the price upon which the hedge analysis was conducted.

### Accounting

In one embodiment, the Accounting stage 600 involves the production of financial statements or spreadsheets containing the details of each transaction. The financial statements or spreadsheets may include, without limitation, transaction identification number, entry date, transaction date, order identification number, type of transaction, financial instrument information, account information, balance data, initial balance, investment allowance, investment amount, investment balance, investment profit, investment profit percentage, management fees, fund balance, fund profit, fund profit percentage, purchase price, sale price, quantity of financial instruments, percentage of particular hedge positions attributed to each client and/or account, gross profit, net profit, gross profit percentage, net profit percentage, or other accounting information.

The automatic production of these detailed statements or spreadsheets may facilitate the verification of the accuracy of the executed trades. If there are mismatches in the trading, the error may be immediately identified and addressed with the brokerage entities. Accountants may also use the statements or spreadsheets to audit the find on as much as a daily basis. The production of such documents may make the accounting process more efficient and may cause increased transparency due to the capability to produce frequent client statements.

### Client

In one embodiment, the Client stage 700 involves The Hedge Fund Management System may automatically produce periodic statements for clients, thus increasing transparency and accountability of the fund managers. The client statements may disclose, without limitation, the Client's Gross Profit, Client's Net Profit, Applied Incentive Fess, Fund Holdings Amount, Fund Holding Profit, Client's Fund Balance, Client's Watermark, Client's Initial Balance, Client's End Balance, Client's Deposits or Withdrawals from the fund, or any other information based on the accounting data.

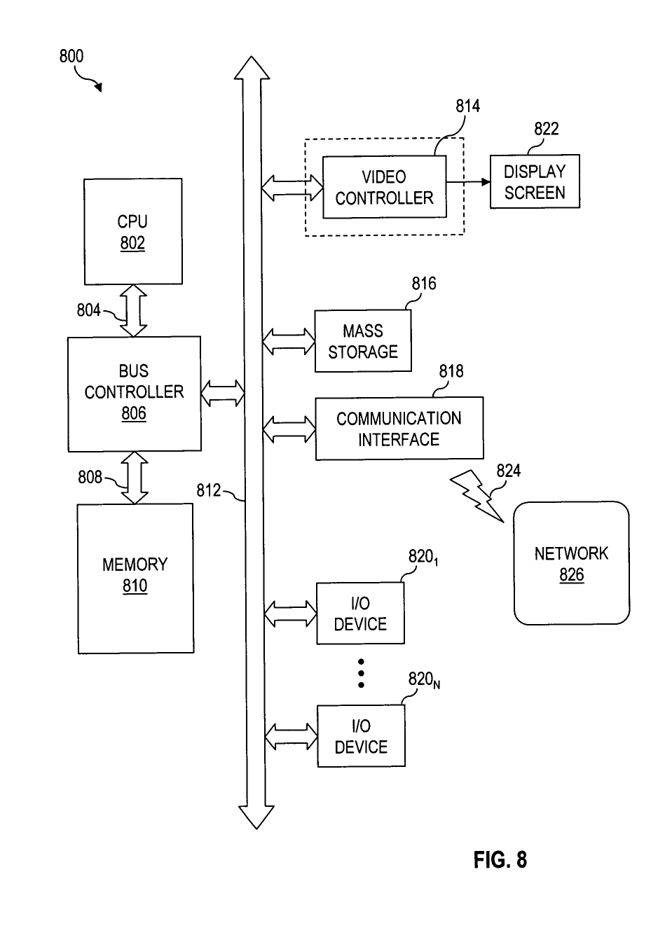

In the foregoing description, the computers may be devices including circuitry capable of processing data. A description of an exemplary computer is herein described. Referring to FIG. 8, the computer 800 comprises a processor, a data processor, or a central processing unit (CPU) 802. The illustrated CPU 802 includes an Arithmetic Logic Unit (ALU) for performing computations, a collection of registers for temporary storage of data and instructions, and a control unit for controlling operation for the computer 800. The CPU 802 may be a microprocessor, a microcontroller, a digital signal processor, a reduced instruction set computer (RISC), an application specific integrated circuits, and the like. Although shown with one CPU 802, computer 800 may alternatively include multiple processing units.

The CPU 802 is coupled to a bus controller 806 by way of a CPU bus 804. Bus controller 806 provides an interface between the CPU 802 and memory 810 via memory bus 808. Moreover, bus controller 806 provides an interface between memory 810, CPU 802 and other devices coupled to system bus 812. It should be appreciated that memory 810 may be system memory, such as synchronous dynamic random access memory (SDRAM) or may be another form of volatile memory. It should further be appreciated that memory 810 may include non-volatile memory, such as ROM or flash memory. The system bus 812 may be a peripheral component interconnect (PCI) bus, Industry Standard Architecture (ISA) bus, etc. Coupled to the system bus 812 are a video controller 814, a mass storage device 816, a communication interface device 818, and one or more input/output (I/O) devices 820ₗ-820_{N}. The video controller 814 controls display data for displaying information on the display screen 822. In another embodiment, the video controller 814 is coupled to the CPU 802 through an Advanced Graphics Port (AGP) bus.

The mass storage device 816 includes, but is not limited to, a hard disk, floppy disk, CD-ROM, DVD-ROM, tape, high-density floppy, high-capacity removable media, low-capacity removable media, solid-state memory device, and the like. The mass storage device 816 may include any other mass storage medium. The communication interface device 818 includes a network card, a modem interface, etc., for accessing network 826 via communications link 824. The communication link 824 may be a medium or channel of communication including, but not limited to, a telephone line, a modem connection, an Internet connection, an Integrated Services Digital Network (ISDN) connection, an Asynchronous Transfer Mode (ATM) connection, a Digital Subscriber Line (DSL) connection, a TCP/IP connection, a frame relay connection, an Ethernet connection, a coaxial connection, a fiber-optic connection, satellite connections, wireless connections, radio frequency (RF) links, electromagnetic links, two-way paging connections, etc. and any combination thereof. The network 826 may include a local area network (LAN), a wide area network (WAN), a worldwide area network, such as the Internet or the World Wide Web, an Intranet, or any combination thereof.

The I/O devices 820ₗ-820_{N} may include a keyboard, mouse, trackball, voice recognition device, light pen, 3D sensor, scanner, audio/sound card, LCD or CRT monitors, printer, plotter, fax, and the like. The I/O devices 820_{l‘-}820_{N} may also include disk drives, such as compact disk drives, digital disk drives, tape drives, magnetic storage drives, digital video disk (DVD) drives, laser disk drives, magneto-optical disk drives, high density floppy drives, high-capacity removable media drives, low-capacity media devices, and any combination thereof.

Preferably, the computer 800 further includes an operating system (OS) and at least one application program, which in one embodiment, is loaded into memory 810 from mass storage device 816 and launched after Power On Self Test (POST). The operating system is a set of one or more programs, which control the computer system's operation and the allocation of resources. The application program may be a set of one or more software programs that performs a task desired by the user, such as sending messages and fund transfers from one computer to another over the network 826. The application program may also be a set of one or more software programs that computes data to generate outputs to be used in the management of a hedge fund.

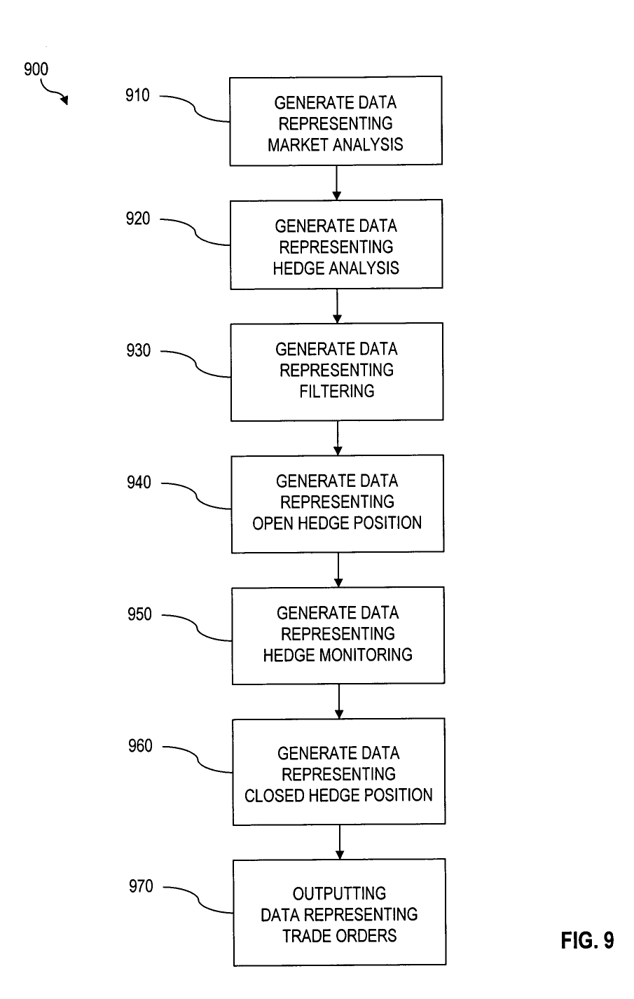

The disclosed method embodiments may also be programmed into software stored on memory devices such as hard disks, floppy disks, CDs, DVDs, tapes, high-density floppys, high-capacity removable media, low-capacity removable media, solid-state memory devices, and the like. For example, as illustrated in FIG. 9, there is shown a flow chart depicting an embodiment of a method for managing hedge funds 900, which includes generating data representing the conducting of market analysis to identify and filter a pool of financial instruments for the construction of a hedge portfolio (block 910), generating data representing the conducting of computerized quantitative analysis on combinations of the financial instruments in the hedge portfolio database to identify potential hedge positions (block 920), generating data representing the filtering of at least one of the combinations based on filtering parameters to form a clearance combination (block 930), generating data representing the placement of a trade order to open a hedge position based on the clearance combination (block 940), generating data representing the monitoring of the hedge position to determine whether trading parameters have been met (block 950), generating data representing the placement of a trade order to close the hedge position (block 960), and outputting the data represent the trade order placements in the form of values, figures, spreadsheets or illustrations (block 970). The generated data may also be outputted on the display screen 822 or by one or more I/O devices 820ₗ-820_{N}. It should be understood that the output of the application program may be used for marketing and sales purposes, as well as for the proper administration of a hedge fund.

1. A method for managing hedge funds, comprising:
conducting market analysis to identify and filter a pool of financial instruments for the construction of a hedge portfolio database,
conducting computerized quantitative analysis on combinations of said financial instruments in said hedge portfolio database to identify potential hedge positions,
filtering at least one of said combinations based on filtering parameters to form a clearance combination,
placing a trade order to open a hedge position based on said clearance combination,
monitoring said hedge position to determine whether trading parameters have been met, and
placing a trade order to close said hedge position.

2. The method according to claim 1, wherein conducting computerized quantitative analysis on combinations of said financial instruments in said hedge portfolio database includes calculating match, reward, risk, and variance values.

3. The method according to claim 1, further comprising:
simulating trading of at least one of said combinations to optimize said filtering parameters.

4. The method according to claim 3, further comprising:
generating accounting data based on said trade orders.

5. The method according to claim 4, further comprising:
generating client statements based on said accounting data.

6. A system for managing hedge funds, comprising:
means for conducting market analysis to identify and filter a pool of financial instruments for the construction of a hedge portfolio database,
means for conducting computerized quantitative analysis on combinations of said financial instruments in said hedge portfolio database to identify potential hedge positions,
means for filtering at least one of said combinations based on filtering parameters to form a clearance combination,
means for placing a trade order to open a hedge position based on said clearance combination,
means for monitoring said hedge position to determine whether trading parameters have been met, and
means for placing a trade order to close said hedge position.

7. The system according to claim 6, wherein said means for conducting computerized quantitative analysis on combinations of said financial instruments in said hedge portfolio database includes means for calculating match, reward, risk, and variance values.

8. The system according to claim 6, further comprising:
means for simulating trading of at least one of said combinations to optimize said filtering parameters.

9. The system according to claim 8, further comprising:
means for generating accounting data based on said trade orders.

10. The system according to claim 9, further comprising:
means for generating client statements based on said accounting data.

11. A system for managing hedge funds, comprising:
an input device,
a memory device,
a processor, coupled to said input device and said memory device, said processor generating
(i) data representing the conducting of market analysis to identify and filter a pool of financial instruments for the construction of a hedge portfolio,
(ii) data representing the conducting of computerized quantitative analysis on combinations of said financial instruments in said hedge portfolio database to identify potential hedge positions,
(iii) data representing the filtering of at least one of said combinations based on filtering parameters to form a clearance combination,
(iv) data representing the placement of a trade order to open a hedge position based on said clearance combination,
(v) data representing the monitoring of said hedge position to determine whether trading parameters have been met,
(vi) data representing the placement of a trade order to close said hedge position, and
an output device, coupled to said processor, to output said data representing said placement of said trade orders.

12. The system according to claim 11, wherein said data representing the conducting of computerized quantitative analysis on combinations of said financial instruments in said hedge portfolio database includes calculating match, reward, risk, and variance values.

13. The system according to claim 11, wherein said processor further generating:
data representing the simulation of trading of at least one of said combinations to optimize said filtering parameters.

14. The system according to claim 13, wherein said processor further generating:
data representing accounting data based on said trade orders.

15. The system according to claim 14, wherein said processor further generating:
data representing client statements based on said accounting data.

16. A computer program product for managing hedge funds, said computer program product comprising:
a computer usable medium having a computer readable program code embodied in said medium for causing a computer to:
conduct market analysis to identify and filter a pool of financial instruments for the construction of a hedge portfolio database,
conduct computerized quantitative analysis on combinations of said fmancial instruments in said hedge portfolio database to identify potential hedge positions,
filter at least one of said combinations based on filtering parameters to form a clearance combination,
place a trade order to open a hedge position based on said clearance combination,
monitor said hedge position to determine whether trading parameters have been met, and
place a trade order to close said hedge position.

17. The computer program product according to claim 16, wherein said computer readable program code causes said computer to calculate match, reward, risk, and variance values when conducting hedge analysis to identify combinations of said financial instruments in said hedge portfolio for potential hedge positions.

18. The computer program product according to claim 16, wherein said computer readable program code further causes said computer to:
simulate trading of at least one of said combinations to optimize said filtering parameters.

19. The computer program product according to claim 18, wherein said computer readable program code further causes said computer to:
generate accounting data based on said trade orders.

20. The computer program product according to claim 19, wherein said computer readable program code further causes said computer to:
generate client statements based on said accounting data.
